(19) United States
(12) Patent Application Publication
(10) Pub. No.: US 2007/0124027 A1
(43) Pub. Date: May 31, 2007

(54) Information system for motor vehicles

(75) Inventors: Peter Betzitza, Sindelfingen (DE); Michaela Ludwig, Ostifildern (DE); Siegfried Rothe, Denkendorf (DE); Manja Zedler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/572,642

(22) PCT Filed: Aug. 18, 2004
(86) PCT No.: PCT/EP04/09232

§ 371 Date: Oct. 10, 2006

(30) Foreign Application Priority Data
Sep. 20, 2003 (DE) 103 43 683.9

(51) Int. Cl. G06F 17/00

(52) U.S. Cl. 701/1

(57) ABSTRACT

A system for providing information as a function of factors which place a workload on the driver when he is driving a motor vehicle. Information is output as a function of the load factors which act objectively on the driver, driver activities and driver-specific driver characteristics which influence the driving of the vehicle. The system is advantageously used in motor vehicles for the purpose of relieving the load on the driver so that very largely in all driving situations the driver is prevented from being overloaded, permitting the vehicle to be driven in a relaxed way.

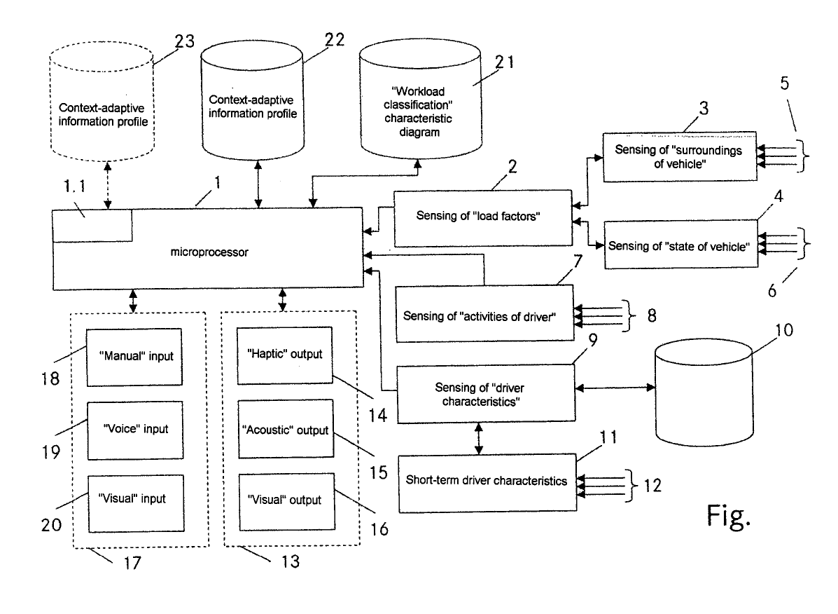

### BACKGROUND AND SUMMARY OF THE INVENTION

The invention relates to a system for providing information in a motor vehicle as a function of the state of the driver. Such a system is known from German Patent Document DE 199 52 857 C1.

Modern information systems for vehicles use ever more complex systems for driving a vehicle and for controlling comfort functions as a basis for providing drivers with a vast quantity of information which is also increasing, resulting in the driver possibly being subjected to overloading—despite some of the information being supportive—and as a result dangerous situations in road traffic cannot be prevented from occurring. Overloading can result, on the one hand, from the objective load factors which act on the driver, such as the state of the road traffic, conditions relating to the surroundings, or state of the vehicle, for example skidding, becoming too large and, on the other hand, from the current physical or psychological state of the driver no longer permitting the usual level of loading, that is to say the driver is subjected to an excessive workload. Whether a driver feels subjected to an excessive workload is initially situation-specific and depends principally on individual characteristics, that is to say on features of the personality of the driver.

In the text which follows, the term “workload” is understood to refer to the psychological workload which is subjectively perceived by the driver on the basis of objectively measurable loading and the features of the driver's personality. The measurable load factors when a vehicle is being driven relate, for example, to the state of the traffic, the state of the road, the type of road, that is to say whether it is the freeway, country road or town road, to the state of the vehicle, for example defects in the vehicle, the driving stability, steamed up or ice covered window panes or temperature values in the passenger compartment. A wide variety of systems and methods are known for measuring the workload on a driver.

For example, Japanese Patent Document JP 2002 010 995 A describes a method for determining the workload value of a driver while he is driving in a motor vehicle, in which method physiological data of the driver, specifically his pulse frequency and breathing frequency, are used for this purpose. The evaluation of the data leads to a classification according to psychological workload, physical workload and habitual workload in the form of a respective numerical value. Depending on the ratios between these values, the current situation of the driver is assigned a category with a specific workload value and a driver support action is selected as a function of this value by, for example, automatically activating an inter-vehicle distance control system (ACC), an automatic brake system or a lane changing assistance system in order to relieve the driver of his driving tasks. This method also provides for acoustic or visual warning signals to be generated when specific workload values of the driver occur.

Furthermore, German Patent Document DE 100 42 367 A1 discloses a method and a device for diagnosing the fitness of a driver to drive in a motor vehicle, in which method physiological data of the driver, which is collected while he is driving, is used to evaluate the driver's state and is combined with data relating to the instantaneous driving state of the vehicle or with data relating to the instantaneous traffic situation and the fitness of the driver to drive is estimated therefrom and, if appropriate, warnings which are based on this estimation of the fitness to drive are output to the driver and, if necessary, assistance measures are initiated. In addition, in this method, besides the currently measured physiological data of the driver his health-related data, which is acquired outside the vehicle, in particular his biographic data, is used to estimate the instantaneous load on the driver. If overloading of the driver is detected, or a workload on the driver which is not adequate for this situation is detected, a corresponding emergency call signal is transmitted, for example using GSM radio, in order to be able to initiate assistance measures.

The collection of the driver's physiological data can, for example, be collected by means of corresponding sensors on the steering wheel of the vehicle, as is known, for example, from DE 195 45 848 A1. In addition, physiological data can also be determined by means of video recordings in order, for example, to be able to draw conclusions about the driver's state by means of his blinking frequency, as is presented in the abovementioned DE 100 42 367 A1. Finally, sensor systems according to the abovementioned JP 2002 010 995 A for measuring the pulse frequency can be accommodated in the seatbelt.

German Patent Document DE 100 39 795 A1 discloses a method for warning a driver of a vehicle in which method, before a warning is output, the attentiveness of the driver of the vehicle is determined, in which case a warning of a critical situation is output exclusively as a function of the degree of attentiveness determined, i.e. for example when a high level of attentiveness is determined this output is even suppressed. In this context, the attentiveness of the driver is determined by detecting the viewing direction, the blinking frequency and/or the position of the head. The determination of the attentiveness includes also the secondary activities carried out by the driver in addition to his driving task which are, for example, operating and using audio equipment, navigation systems or mobile radio devices. Finally, a state of tiredness is determined by measuring the body temperature and/or the pulse frequency of the driver, and the attentiveness of the driver is determined therefrom. In this known method, the warnings are not only output merely as a function of the degree of attentiveness of the driver which is determined but also as a function of the state of the vehicle so that critical vehicle state situations are detected by means of assistance systems such as parking aids, inter-vehicle distance control systems (ACC) and detection of the hard shoulder, and warning messages are generated at an early or late point as a function of the detected degree of attentiveness of the driver. In this known method, physiological data of the driver such as the pulse frequency and body temperature are also collected by means of sensors which are arranged on the steering wheel.

Furthermore, German Patent Document DE 197 53 160 C1 discloses a device for detecting an imminent accident situation of a vehicle in which changes in movement of the hands are detected by means of an image recognition system and the speed with which the changes in movement occur is determined therefrom. If these changes in movement indicate a panic-like movement, at least one safety system is activated. In this context, it is assumed from experience that drivers who recognize a directly imminent accident situation turn the steering wheel in a panic in order to avoid the accident situation. In addition to detecting the movement of the hands, the movement of the driver's feet which activate the accelerator pedal and brake pedal can also be detected and likewise lead to the triggering of a safety system if the speed of movement of a foot exceeds a predefined threshold which indicates a panic reaction by the driver.

In order to determine the workload value of a driver, according to U.S. Pat. No. 6,061,610 the steering angles when driving are recorded by means of a steering angle sensor and this steering angle pattern is compared with a standard pattern which corresponds to a steering angle pattern of a load-free driver. A workload index value is generated as a function of the result of the comparison.

Furthermore, German Patent Document DE 198 18 239 A1 discloses an apparatus for warning a driver of a motor vehicle that he is falling asleep, which apparatus comprises a device for detecting the vehicle's surroundings, a device for sensing a referenced driving style of the driver, a comparison logic for evaluating the reference driving style with an actual driving style which is determined by the device for detecting the vehicle's surroundings, and a warning device which can be actuated by the comparison logic. If a lateral movement of the motor vehicle with respect to the boundary of the carriageway is detected on the basis of the evaluation of the data of the device for detecting the vehicle's surroundings, this lateral movement is compared with the reference driving style by means of the comparison logic and when a threshold value is exceeded a warning device for generating a haptic, acoustic or visual warning signal is actuated.

These known methods and devices are used essentially to warn the driver in hazardous situations or to relieve him in such situations by correspondingly controlling vehicle systems. In this context, hazardous situations are detected as such if an extreme state of the driver, that is to say either a risk of him falling asleep or overloading or collapse of the driver is detected, in which case overloading is also assumed in extreme traffic situations. The corresponding measures are therefore effective only in preventing a hazardous situation which is already occurring.

An information system for motor vehicles is known from German Patent Document DE 299 16 000 U1, in which the density of information acting on a driver is controlled as a function of the current state of the vehicle in terms of the possibilities of functions which can be activated by the driver. For this purpose, sensor devices for sensing vehicle states such as, for example, the current speed, the selected gear or else the quantity of fuel which is present in the fuel tank are provided. The operation or activation of functions which can be triggered by means of operator control elements is blocked in specific states of the motor vehicle, for example when traveling fast, in order to avoid unnecessarily distracting the driver from the events on the road. Thus, for example at a high speed it is possible to block the operation of an air conditioning system, a navigation system or an audio system. In order to characterize this state, the corresponding menu items are, for example, removed from a display device or are characterized in an appropriate different way on said device. There are also vehicle states in which it is possible to trigger a specific function but where this triggering is not recommended on the basis of these vehicle states. In this case, a warning message may be issued, for example by means of a corresponding graphic display or else in an acoustic or haptic fashion.

The selection of the way of outputting the information which is proposed with this known system relates only to the state of the motor vehicle, without, however, taking account of the individual driver characteristics in terms of his fitness to drive, for which reason the driver could feel that he loses control to this system.

The generic system which is described in German Patent Document DE 199 52 857 C1 takes into account the state of the driver in the control of data sources, the means for controlling vehicle components and the means for controlling optical and/or acoustic display devices. The means for detecting the state of the driver in terms of his state of mind or mood comprise a camera and a microphone whose measurement data is intended to permit an assignment to a state of mind of the driver by means of a comparison with stored reference data. Depending on the driver's mood which is determined, only specific information is represented so that a selection of information or filtering of information also occurs here. The information which is made available for display, for example the speed, the temperature of the cooling water, the tire pressure or the filling level of the fuel tank, is supplied by vehicle sensors.

In addition, emergency functions or assistance functions for the driver are activated with this known system as a function of the state of the driver which is determined. For example, information which relates to an operator control instruction, user prompting or an assistance system for the operation and control of vehicle components is displayed to the driver, for example as a function of the state of the driver, in order thus to support him as he operates the systems.

A braking assistant, which, in the case of a detected emergency, for example when the driver collapses, carries out slow braking and at the same time ensures that declutching occurs so that the vehicle is not accelerated further, serves as an emergency function.

In this known system, the state of the driver is described by the terms “state of mind” and “mood”. In order to obtain information about such a state of the driver, the voice pattern is analyzed by means of the microphone since it is assumed that said pattern changes in a driver who is excited and, for example, muscular tension, changes in temperature or else violent and sudden movements are detected by evaluating the driver's facial area. Finally, in a stress situation calming music will automatically be played to the driver. It is not ensured that there is a high probability that the physiological data which is collected with the microphone and the camera will indicate the driver's current workload, since a changed voice pattern may also be due to the speech content of a conversation which is being conducted with a front seat passenger or a throat illness, muscular tension or changes in temperature may be due to the climate in the passenger compartment and finally violent and sudden movements could merely indicate the driver's high level of interest in an object which is located outside the vehicle, or may simply be caused by a conversation with the front seat passenger. Therefore, reliable determination of the workload level of the driver requires further information which permits a specific state of the driver to be confirmed, since otherwise the risk of misinterpretation is very high, and in a worst case situation an emergency could incorrectly be assumed with this known system.

German Patent Document DE 102 11 069 A1 discloses a similar method and an apparatus for providing information in which method the cognitive load on the driver is determined on the basis of vehicle data such as speed of the vehicle, internal noise in the vehicle, acceleration of the vehicle, and in addition on the basis of data relating to the surroundings such as weather conditions and road conditions, and finally also on the basis of driver factors such as steering behavior or use of a mobile telephone. The information to be output is then selected on the basis of the cognitive loading which is determined. The disadvantage of this known method is likewise that the individual driver characteristics are not taken into account so that for this reason there is the risk of the driver feeling that he is losing control and as a result the safety-related aspect is only inadequately fulfilled.

Furthermore, German Patent document DE 197 07 188 A1 discloses a system for providing information in which an information device is placed automatically in defined operating modes as a function of the vehicle's operating mode. In this context, sensor data on the speed of the vehicle, or the operating status of an ABS control device or of the ignition system is collected here as input data and also speed dialogs with the vehicle system are recorded and evaluated. Finally, dynamic vehicle states such as frequent braking and accelerating or drastic steering maneuvers are also sensed and processed. It is proposed, for example, to output current operating characteristic values such as engine values and vehicle values (for example temperature, speed) as one operating mode and a further operating mode relates to the outputting of traffic information or to an electronic route guidance process using a corresponding map, a telephone control system, the possibility of using a PC function or a “customer support” operating mode with information from the operating instructions or information about service instructions and circuit diagrams.

With this known system, the intention is to simplify the operation and use of corresponding devices in a vehicle so that danger in traffic is prevented as far as possible.

This known system also takes no account of the driver's individual ability to bear loads when driving a vehicle when the information which is offered to the driver is selected.

Finally, European Patent Document EP 0 590 588 B1 discloses a driving assistance system for facilitating driving of a vehicle by a driver, which system has an information processing unit which, as a function of the data from a device for detecting the surroundings, for detecting objects which are located directly in the vehicle's surroundings, and as a function of the data of a device for determining the driving state, for the purpose of determining one of a plurality of driving states of the vehicle, generates a reference information item which corresponds to the detected driving state and displays it on a display device. The driving operation reference information consists, for example, in the fact that in a detected traffic overload state, i.e. driving in a traffic jam, it is indicated that the vehicle traveling in front starts moving or in the fact that the distance between the vehicles is displayed in a detected normal driving state and at the same time the driver is informed about the suitable distance between the vehicle traveling in front and his own vehicle, or in the fact that, in a driving state which corresponds to driving in a narrow passage obstacles are displayed to the driver as well as the approaching of said obstacles to the driver's vehicle, or steering information for parking are to the driver in a parking mode.

This known driver assistance system also does not take into account the individual ability of the driver to bear loading, as a result of which there is the risk of the driver feeling that he is being controlled.

The object of the present invention is to specify a system for providing information as a function of the state of the driver in a motor vehicle, in which system the driver uses only a small amount of his resources in terms of attentiveness as he takes in the information offered individually to the driver by this system, and said system at the same time supports the driver in his driving task and is thus intended to contribute to road safety.

This object is achieved by:
a) a device for sensing objective load factors, in particular the state of the motor vehicle and/or the conditions of the motor vehicle relating to the surroundings, which act on the driver,
b) a device for sensing the driver activities,
c) a device for sensing the driver-specific driver characteristics which influence the driving of the vehicle,
d) an information processing unit for determining an information profile as a function of the load factors which act on the driver, the driver activities and the specific driver characteristics which influence the driving of the vehicle, and
e) an output device for outputting the information which is determined by means of the information profile.

On the basis of the information profile, which is determined information, preferably operator control information and vehicle state data and information from communications systems and assistance systems as well as entertainment information is provided to the driver as a function of the events on the road and the state of the vehicle in such a way that the vehicle can be operated and driven safely while taking into account the driver's current ability to bear loading. The information profile which is generated in this way thus leads to a “personalized” information package for the driver. The communication with the vehicle is structured according to the invention in such a way that the driver is neither distracted, disturbed or overloaded by the information which is provided, nor does he feel controlled by the system according to the invention, that is to say the system experiences a high level of acceptance by the driver.

The high level of acceptance of this system by the driver is achieved in particular by virtue of the fact that not only the objective loading factors of the driver are sensed in the current driving situation but also those driver characteristics which are relevant for driving a vehicle, for example tiredness, stressed state and the driver-specific characteristics, specifically the driver properties, such as his state of health, driving style in terms of acceleration, steering or braking, nervousness of the driver, driving competence or general ability to bear loading.

According to one particularly advantageous embodiment of the invention, the state of the driver can be determined in terms of his workload level as a function of the objective load factors, the activities of the driver and the properties of the driver which influence the driving of the vehicle, and can be classified in order to determine the information profile by reference to this classification. In this context, the workload can be divided into various categories such as “low workload”, “medium-ranking workload” or “heavy workload”, in which case in terms of the assignment to the first-mentioned category the driver is very stress resistant, that is to say is able to bear a heavy workload, while in the last-mentioned category the driver would have very little stress resistance and thus also be able to bear little workload. As a result, when determining the information profile it is possible to ensure particularly satisfactorily that the driver maintains control over the vehicle under all circumstances, feels relaxed and can trust the system and can react safely to unexpected events at any time.

The level of workload, that is to say the workload level of the driver while driving, is determined from a large number of factors so that a high level of accuracy in terms of the classification of the workload is possible, while, in particular, classification can also be carried out with respect to the affected means of perception, to which workload level the sense of sight, hearing and/or of touch is subjected.

Thus, not only data relating to the surroundings, which is provided by surroundings sensors, telematic systems, communication systems with other vehicles or stationary communication systems is sensed in the case of the objective load factors but also vehicle state data, that is to say essentially operating data and state data such as, for example, the technical state, state of wear of the windshield wipers, state of the tires, the temperature of the passenger compartment, misted up and ice covered window panes and finally also the operating state of assistance systems in the vehicle.

Important data for determining the workload level is supplied by the sensing of the driver characteristics which are decisive for the driving of the vehicle. In this context, not only the short-term characteristics such as tiredness, stressed state or emotional state are sensed but also the driver-specific characteristics, specifically the driver properties such as, for example, state of health, driver-restrictive characteristics such as wearer of glasses or of a hearing aid, anxiousness (about tunnels or bridges), driving style in terms of acceleration, steering or braking, driver nervousness, driving competence or general ability to bear loading.

The short-term characteristics may be, for example, as physiological data such as conductivity of the skin, viewing direction, width of pupils or ECG values.

The collection of data for the driver-specific characteristics can be carried out, for example, by means of a corresponding questionnaire when the vehicle is purchased and can be stored in the data memory which is provided for this purpose or can be input directly by the driver into the system, that is to say the data memory.

Finally, activities of the driver such as steering activity or pressing on a pedal, also the level of speed of the vehicle or rapid driving up to a vehicle traveling in front with determination of the distance, a lane change, turning off the road, cornering, reversing, traveling through a tunnel or traveling through an entry or exit are also sensed and used to determined the workload level.

With the system according to the invention it is possible for the information which is provided to be adapted to the driver on an extremely specific basis.

According to one advantageous development, it is possible for the information type of the information which is to be output to be determined as a function of the workload level which is determined, that is to say whether warning messages, operator control information or entertainment information is to be output, and the time when the information is output can also be determined according to this. Finally, the information type or the time when the information is output can be defined as a function of the type of workload which is determined.

In addition, the quantity and density of information can be determined by the workload level or the type of workload, for example whether the information is displayed concisely or in detail, whether a large or small number of information units is presented over a given display area or whether the speaker of a voice output speaks quickly or slowly.

Finally, it is possible for the output medium to be determined as a function of the load level or the type of loading, that is to say whether the information is output visually, acoustically or haptically or in a combination thereof.

Thus, for example an exclusively acoustic output may constitute a smaller workload for the driver in certain situations than interaction with the vehicle by means of a haptic or visual means of communication.

Furthermore, the type of output of visual data, specifically as text data, symbolic data, graphics or videos may be controlled as a function of the workload level or the type of workload. In particular, the length of text data can also be output as a function of the aforesaid variables.

In a further advantageous embodiment in which functions can be triggered by means of operator control elements and these functions are categorized into operating options of differing extent, an operator option can be offered to the driver by means of a selection device as a function of the workload level or the type of workload. The operator input can be carried out acoustically, visually and/or haptically here as a function of the workload level or the type of workload.

Finally, in a last advantageous embodiment of the invention, a “minimal” operator option comprises merely the functions necessary for driving and excluding options which are not relevant to driving.

In the text which follows, the invention will be explained and presented in more detail in conjunction with the FIGURE. This FIGURE shows a block circuit diagram of the system according to the invention as an exemplary embodiment.

### BRIEF DESCRIPTION OF THE DRAWING

The sole FIGURE is an information and operator control system of the present invention.

### DETAILED DESCRIPTION OF THE DRAWING

The block circuit diagram shows an information and operator control system with a central information processing unit 1 which operates, for example, as a microprocessor μP, and to which a series of data and information items are fed in order to determine the workload of the driver therefrom.

For this purpose, the objective load factors which act on the driver are sensed by means of a device 2 by detecting only data relating to the surroundings of the vehicle with a device 3, and only vehicle state data with a device 4.

The device 3 is connected to corresponding sensors or information sources, such as telematic systems or communication systems, also vehicle-to-vehicle communication systems, via an interface 5 in order to collect the desired data. This is information and data relating to the part of a route on which the vehicle is currently traveling, which class of road, whether it is a freeway, federal highroads, cross country roads, through roads or a residential area/footpath, in addition data about bridges, tunnels, entries to and exits from freeways, data about the nature of the edge of the road, in addition data relating to the difficulty of the section of a route, data about positive and negative gradients on the route, the width of the road, railway crossings, one way roads, roads with priority, pedestrian crossings, traffic islands, pedestrian zones, roads on which children play, roadworks, the number of lanes, constrictions on the carriageway, the end of a lane, reductions in the width of a lane, widening of a lane, unevenness of the ground, roundabout, complex intersections, special traffic configurations (for example circular intersection), radii of curvature of bends, road nodes, speed categories and data from a road sign recognition means (including states of traffic lights). Further data on the surroundings relate to the condition of the road (risk of aquaplaning, dry, wet, snow covered or covered in ice, surface of the road, grooves, pebbles, sand, bumpiness) and the state of traffic (density of traffic, oncoming traffic, blinding effect of oncoming vehicles, stop and go traffic, end of traffic jam (moving or stationary), priority infringement by other road users, driving in a multi-storey car park, suddenly occurring obstacles (for example pedestrians, cyclists or motorcyclists), distance or relative speed with respect to a vehicle which is traveling in front or following as well as environmental conditions (weather conditions and visibility conditions such as rain or fog, number of passengers, noise level in the vehicle, light conditions, position of the sun, time of day, time of year, geographic location, external temperature, side wind conditions).

The device 4 is also connected to corresponding sensors or information sources relating to the state of the vehicle via an interface 6 in order to collect the desired data. This data is operating data of the vehicle and information relating to critical defects in the vehicle, (for example brake failures), misted up/iced up window panes, operating state of ABS/ESP/parking assistance/inter-vehicle distance control assistance system/bend warning systems, the yaw rate, technical state of the vehicle, state of wear of the windshield wipers, state of the tires, tire pressure, winter tires/summer tires, quantity of fuel, temperature of passenger compartment, seat heater and trailer hitch (for example whether trailer or camper is hitched).

With a device 7, the activities of the driver are sensed via an associated interface 8 which is also connected to corresponding sensors and information sources. These activities of the driver relate to the activation of operator control elements (radio, navigation system, seat adjustment means, brake pedal and accelerator pedal, etc.), observing displays in the vehicle, observing road signs, in particular direction indicating signs and traffic lights, the speed of the vehicle, the type of acceleration/deceleration, the position of the accelerator pedal, the position of the brake pedal, the braking torque, kickdown, the activation of the clutch, the steering angle (including steering angle speed, steering angle acceleration), the selection of gears, activation of the hooter and the flashing indicator lights (including the warning flashing indicator lights), use of the telephone, adjustment of the mirrors, activation of the air conditioning system and operation of the control and display instruments. Further information items which describe the activities of the driver relate to the driving maneuvers which are brought about by the driver such as turning off the road, overtaking, approaching bends and vehicles traveling ahead, traveling through bends, changing lane and parking.

With a device 9, the driver characteristics are sensed, a differentiation being made between driver properties, that is to say long-term driver characteristics, which are stored in a data memory 10 and short-term driver characteristics which are determined by means of a device 11. The data memory 10 and the device 11 are connected to the device 9. In order to sense the short-term driver characteristics, the device 11 is connected to corresponding sensors and information sources via an interface 12.

The short-term driver characteristics describe essentially the current state of the driver in terms of tiredness, psychological fatigue or saturation, stress, motivation (whether for example traveling to work, driving to holiday destination, driving on a shopping expedition), time pressure, visual/acoustic/mental distraction, emotional state (anger, annoyance, frustration, joy), influences of alcohol or drugs and degree of familiarity with the route being traveled on.

Many of these characteristics can be sensed by detecting the physiological data of the driver, for example tiredness, stressed state, psychological fatigue or saturation, emotional state and influences from alcohol and drugs. Physiological data which is determined is, for example, conductivity of the skin, the viewing direction of the driver, voice frequency, width of the pupils, pulse frequency and breathing frequency or the blinking frequency. Other characteristics may be obtained indirectly, for example psychological fatigue or saturation can be inferred from monotonous events on the road or monotonous section of a route. Such data may also generally be used to evidence plausibly the driver characteristics. As well as the physiological data, it is also possible to check for the stressed state or to check for the motivation by means of specific driving parameters (for example sensing the steering angle). Navigation information of a navigation system with a learning component can also be used to be able to evaluate, for example the driver's motivation. Driver observation cameras are used to sense the visual distraction of the driver, volume measurements give an indication of the acoustic distraction of the driver. Sensing the activation of operating elements or the steering wheel lock give an indication of haptic workload.

The driver properties, that it to say the long-term driver characteristics relate, for example, to the driving style of the driver with respect to acceleration, steering and braking, nervousness of the driver, anxiousness when traveling through tunnels and bridges, driving competence (experienced or inexperienced driver), general ability to bear loading (endurance, fitness), illness and readiness to act or ability to act, driver-restrictive features (for example restricted sight or hearing) and behavior with respect to risks, gender. These individual data items of a driver can, for example, be determined when the vehicle is purchased by means of a questionnaire in order then to be stored in the data memory 10. It is also conceivable to determine this driver-specific data by means of specially developed tests or else to combine travel data and draw conclusions therefrom.

Data supplied to the sensing devices 2, 7 and 9 is conditioned there and converted into standard values in order to be compared with reference values. For this purpose, these standard values are fed to the information processing unit 1 which determines the current workload level and/or the type of workload on the driver by means of a “workload classification” characteristic diagram which is stored in a data memory 21. For this purpose, the characteristic diagram stored in the data memory 21 has a matrix-like structure so that a category of the workload that is to say the workload level can be assigned to a data record comprising load factor and driver activity, if appropriate also the type of workload, that is to say whether the workload is of a visual, acoustic or haptic kind. In the simplest case it is possible, for example, to carry out classification into three categories such as “low workload”, “medium-ranking workload” and “heavy workload”. This number of categories can of course be increased as desired in order to thus arrive at finer degradations, in particular in view of the selection, made as a function of this classification, of the information to be offered to the driver. In addition, a category can also be defined by further factors, for example with respect to the type of workload or the cause of the workload, for example whether the level of the workload is determined by the severity of the objective load factors acting on the driver or merely by the individual driver characteristics, for example by extreme anxiousness of the driver.

With the workload category which has been determined in this way, the associated information, by accessing a data memory 22, in which context-adaptive information profiles are stored is determined by the central information processing unit 1 and output via an output device 13. This output device 13 contains output means 14 for outputting haptic information, output means 15 for outputting acoustic information and output means 16 for outputting visual information.

The context-adaptive information profiles which are stored in the data memory 22 are made up, for example, of a basic menu comprising subject matters which are relevant to the driver only while he is driving, with the type of information being determined as a function of the load factors, the activities of the driver and the driver characteristics—that is to say in a way which is adaptive to the context—therefore operator control information, warning messages, information messages or entertainment information or information from communications systems such as telephones having to be output, short texts are output by means of the visual output means 16 or in critical driving states only by voice by means of the output means 15, and can even be interrupted or ended in such a case, if appropriate, by the driver by means of a voice instruction “pause” or “stop”. In the case of data relating to the surroundings of the vehicle or vehicle state data which is less critical it is possible to reverse the text abbreviations incrementally or to supplement the menu with further subject matters. The number of increments provided in this context can relate, in a minimal version of two increments, specifically “driving” vehicle state and the “stationary” vehicle state. In addition, finer gradation can be provided by enabling the gradation to occur also as a function of the “severity” of the sensed states either with respect to the surroundings of the vehicle, that is to say the events on the road, and with respect to the driving activities. The quantity of information can also be controlled in the case of acoustic output by, for example, outputting only words and short sentences or long detailed explanations in a voice output system.

In addition to this control of the quantity of information, it is also possible to predefine the density of information as a function of the workload level and the variables which determine this classification. For example, the text information can be output on a display by means of the output means 16 with a small letter size so that a very large amount of information has to be taken in by the driver compared to outputting text with a larger letter size in which the density of information is smaller. When voice output is carried out by means of the acoustic output means 15, a rapidly spoken text leads to a high information density compared to a slowly spoken text.

Finally, the means of communication, that is to say the medium for outputting the information, can be controlled as a function of the aforesaid variables with respect to the workload category, so that a visual, an acoustic and/or a haptic output are possible by means of the output device 13. The type of output can also be controlled by means of these individual means of communication by, for example, outputting texts of different lengths, self-explanatory symbols, images or videos. The acoustic output may be presented as voice, music or as warning signals. The haptic information can be output in the form of vibrations of the steering wheel or oscillations of other parts of the vehicle such as, for example, the driver's seat. In addition, haptic feedback can also be implemented at operating elements. In DE 102 11946 C1 it is proposed, for example, to provide on the steering wheel a sensor and actuator element with which the sense of touch of the driver's hand is stimulated by pressure, tension, electrical voltage or by changing the chemical condition of the surface of the actuator.

There is also provision to change the means of communication if it is detected that, for example, the driver is subject to a heavy visual workload owing to the traffic situation, that is to say the type of workload is determined. Such a change in modality leads, for example, to the auditory sense by means of the acoustic output means 15.

The control of information which is achieved in this way is adapted to the driver in an optimum way, i.e. both to his specific driver characteristics and driver activities and in conjunction with the current driving task to be carried out by him, the severity of which is determined by the loading factors.

The information and operating system according to the single FIGURE also has an input device 17 with a manual input means 18, an acoustic input means 19 for inputting by voice, for example microphone, and with a visual input means 20, for example a device for detecting the hand movement or the viewing direction of the driver.

Optionally, it is also possible to determine an operator control option likewise as a function of the workload classification with respect to the abovementioned variable, which operator control option provides the driver with a specific range of vehicle functions which can be triggered by him by means of operating elements using the input device 17. For this purpose, a data memory 23 is provided which is indicated by dashed lines in order to illustrate the optionality on the FIGURE. This data memory 23 contains different operator control options from which one operator control option is selected by a selection device 1.1, assigned to the information processing unit 1, as a function of the workload level or its classifying variables, specifically the loading factors, the driving activities and the driver characteristics. A minimal operator control option is provided by the fact that all the functions which are necessary to drive the vehicle are offered and can be operated by the driver. Further functions can then be added in accordance with the workload category or the aforesaid variables. The information which is associated with the selected operator control option is made available by access to the data memory 22.

The operator control options can differ by varying the menu depth, that it to say the number of menu levels, and likewise the width of the menu or specific options can be overlaid on the display or removed from it. In particular, input options can be predefined since an acoustic input, that is to say voice input, is less stressful for the driver in critical driving situations than a manual input by means of a switch. It should be decisive for this that the total time for carrying out an operator control task is less than 15 sec, and an average person can read approximately three to four words per second. If it is considered that a vehicle covers a distance of approximately 28 m per second at a speed of 100 km/h, the meaning of the inclusion of, for example, the variable “vehicle state” becomes clear since at this speed a considerable loss of information with respect to the events on the road occurs within a few seconds.

In this way, it is possible to control options in a way which is optimized to the maximum traffic safety so that as a result in particular learner drivers with little driving experience and driving practice are relieved to an optimum degree over a certain period of time and can thus concentrate completely on the traffic.

1-17. (canceled)

18. A system for providing information in a motor vehicle as a function of the state of a driver, said system comprising:
a device for sensing objective load factors which act on the driver,
a device for sensing driver activities,
a device for sensing driver-specific driver characteristics which influence the driving of the vehicle,
an information processing unit for generating an information profile as a function of the objective load factors which act on the driver, the driver activities and the specific driver characteristics which influence the driving of the vehicle, and
an output device for outputting information determined from the information profile.

19. The system for providing information according to claim 18, further comprising a characteristic diagram, stored in a data memory for workload classification whereby, the information processing unit determined the workload level of the driver as a function of the load factors, the driver activities and the driver characteristics which influence the driving of the vehicle, and the information is output as a function of the determined workload level.

20. The system for providing information as claimed in claim 19, wherein the workload is classified in terms of at least one of a visual, acoustic and haptic workload.

21. The system for providing information according to claim 18, wherein, in order to sense the driver activities, the driving maneuvers, which are initiated by at least one of the driver and the operator control element, actuation operations which are performed by the driver are detected.

22. The system for providing information as claimed in claim 18, wherein the device for sensing the driver-specific driver characteristics which influence the driving of the vehicle senses short-term driver characteristics.

23. The system for providing information as claimed in claim 18, wherein the device for sensing the driver-specific driver characteristics which influence the driving of the vehicle senses long-term driver characteristics.

24. The system for providing information as claimed in claim 18, wherein the information processing unit determines the type of information which is to be output.

25. The system for providing information as claimed in claim 18, wherein the information processing unit determines the time when the information which is to be output is output.

26. The system for providing information as claimed in claim 18, wherein the information processing unit determines at least one of the amount of information and the information density.

27. The system for providing information as claimed in claim 18, wherein the information processing unit outputs the information as at least one of visual and acoustic and haptic data.

28. The system for providing information as claimed in claim 22, wherein the visual data is output as at least one of text data and symbolic data and graphics and videos.

29. The system for providing information as claimed in claim 28, wherein the information processing unit determines the length of the text data.

30. The system for providing information as claimed in claim 18, wherein functions are triggered by means of operator control elements and said functions are categorized into operator control options of differing extent and are stored in a data memory and a selection device is provided for determining an operator control option as a function of the load factors, the driver activities and the driver characteristics which influence the driving of the vehicle.

31. The system for providing information as claimed in claim 30, wherein an input device is provided for carrying out the selected operator control option.

32. The system for providing information as claimed in claim 31, wherein the input device has means for operator control input, the information processing unit determining the type of operator control input.

33. The system for providing information as claimed in claim 30, wherein the selected operator control option includes at least the functions which are necessary for driving.

34. The system for providing information as claimed in claim 18, wherein the information which is to be output includes vehicle state information, operator control information, information relating to the surroundings and warning messages as well as information from communications devices.

35. The system for providing information as claimed in claim 22, wherein the short-term driver characteristics include at least one of degree of tiredness, the degree of stress, the degree of distraction, the emotional state and the state under the influence of drugs or alcohol.

36. The system for providing information as claimed in claim 23, wherein the long-term driver characteristics include driving properties comprising at least one of driving style, driving competence, nervousness, anxiousness, state of health, reaction capability and readiness to act.
